(19) United States
(12) Patent Application Publication
(10) Pub. No.: US 2019/0378422 A1
(43) Pub. Date: Dec. 12, 2019

(54) Systems for Assisting Pilots with Emergency Landings

(71) Applicant: Peregrine Innovations, LLC, Englewood, CO (US)

(72) Inventors: David G. Rankin, Centennial, CO (US); Mark S. Synder, Castle Rock, CO (US)

(21) Appl. No.: 16/531,326

(22) Filed: Aug. 5, 2019

(51) Int. Cl. G08G 5/00; G07C 5/06; B64F 5/60; B64D 43/02

(52) U.S. Cl. CPC G08G 5/0047; B64D 43/02; B64F 5/60; G07C 5/06

(57) ABSTRACT

Systems for assisting pilots with emergency landings including a memory device storing computer executable instructions, a processor configured to execute the computer executable instructions and generate display instructions, and a display configured to display an indicator based on the display instructions generated by the processor, the computer executable instructions including determining current flight capabilities of the aircraft, identifying an airport near the aircraft, determining required flight capabilities of the aircraft necessary for the aircraft to land safely at the airport, comparing the current flight capabilities with the required flight capabilities, and determining the indicator to display on the display based on the comparison of the current flight capabilities with the required flight capabilities.

### BACKGROUND

The present disclosure relates generally to systems for assisting pilots. In particular, systems for assisting pilots with emergency landings are described.

In modern aviation, pilots rely on myriad avionics to safely and effectively pilot aircraft. Avionic systems assist pilots with communications, navigation, and management of multiple flight systems. Modern avionics have expanded the flight capabilities of aircrafts and pilots.

However, known avionic systems are not entirely satisfactory for certain scenarios pilots must face. For example, existing avionic systems do not adequately assist pilots with emergency landing scenarios. A particular unmet need with conventional avionic systems is assisting pilots effectively with emergencies occurring during or shortly after take-off. When pilots are suddenly subject to circumstances necessitating a quick, emergency landing, such as aircraft mechanical or electrical issues, conventional avionics fail to effectively assist pilots to decide where best to land the aircraft.

Current avionic systems seeking to assist pilots are often more complex than ideal for making quick assessments in emergency scenarios. For example, pilots faced with emergency circumstances shortly after take-off must quickly assess whether to return to the airport from which they just departed or to proceed towards a different airport or other area where the pilot may attempt to land the aircraft safely. In emergency scenarios where a pilot must quickly determine how best and where best to attempt an emergency landing, overly complex systems can fail to provide pilots with guidance sufficiently quickly and clearly to be interpreted effectively.

Thus, there exists a need for pilot assistance systems that improve upon and advance the design of known avionics. Examples of new and useful pilot assistance systems relevant to the needs existing in the field are discussed below.

### SUMMARY

The present disclosure is directed to systems for assisting pilots with emergency landings including a memory device storing computer executable instructions, a processor configured to execute the computer executable instructions and generate display instructions, and a display configured to display an indicator based on the display instructions generated by the processor, the computer executable instructions including determining current flight capabilities of the aircraft, identifying an airport near the aircraft, determining required flight capabilities of the aircraft necessary for the aircraft to land safely at the airport, comparing the current flight capabilities with the required flight capabilities, and determining the indicator to display on the display based on the comparison of the current flight capabilities with the required flight capabilities.

### BRIEF DESCRIPTION OF THE DRAWINGS

FIG. 1 is a schematic view of an example of a programmable computing device on which the present pilot assistance systems may operate.

FIG. 2 is a schematic view of an example of a mobile electronic device on which the present pilot assistance systems may operate.

FIG. 3 is a schematic view of an aircraft taking off from an airport with conceptual arrows depicting flight path options for a pilot attempting to make an emergency landing.

FIG. 4 is a schematic view of a first example of a system for assisting pilots with an emergency landing of an aircraft, the system including a memory device, a processor, and a display.

FIG. 5 is a front view of one example of the display shown in FIG. 4, the display depicted adjacent to other aircraft system displays and displaying indicators for assisting a pilot with an emergency landing.

FIG. 6 is a flow diagram of computer executable instructions the processor shown in FIG. 4 is configured to follow.

### DETAILED DESCRIPTION

The disclosed pilot assistance systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various pilot assistance systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

Various disclosed examples may be implemented using electronic circuitry configured to perform one or more functions. For example, with some embodiments of the invention, the disclosed examples may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

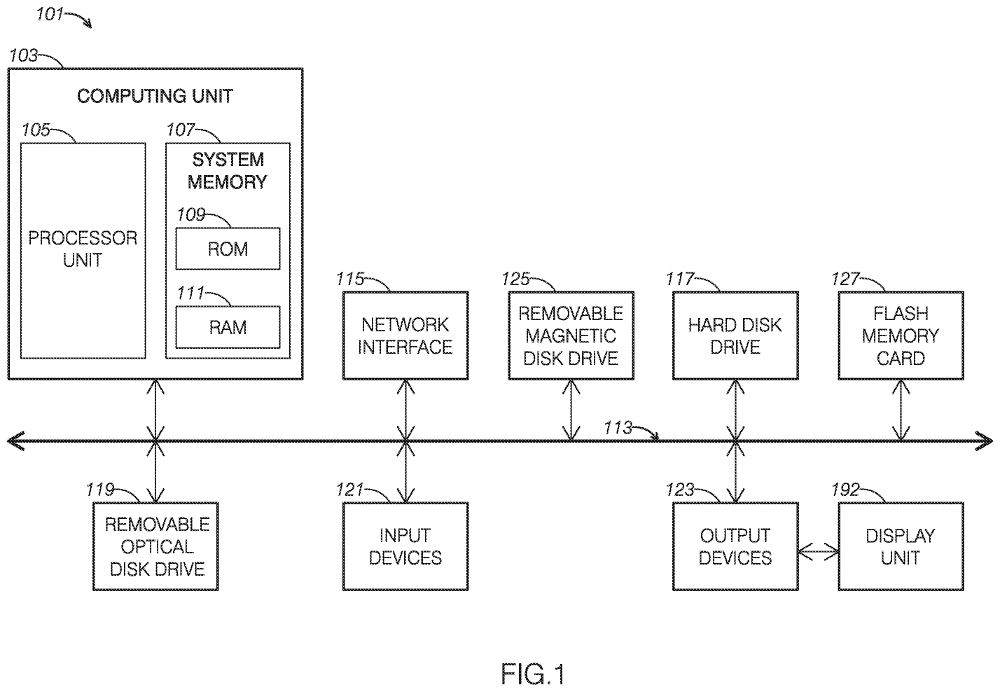

Accordingly, FIG. 1 shows one illustrative example of a computer, computer 101, which can be used to implement various embodiments of the pilot assistance system. The actual computer used by the presently disclosed pilot assistance systems may include different, additional, or fewer components than shown in FIG. 1. The pilot assistance systems described herein may utilize any currently known or later developed computer devices. Computer 101 shown in FIG. 1 may be incorporated within a variety of aircraft electronics, cockpit computing systems, or mobile devices used by pilots, such as cellular phones, smart phones, personal data assistants, global positioning system devices, and the like, or may comprise a standalone computing device, such as a cockpit computer, a laptop, a tablet computer, or a hybrid computing device.

As shown in FIG. 1, computer 101 has a computing unit 103. Computing unit 103 typically includes a processing unit 105 and a system memory 107. Processing unit 105 may be any type of processing device for executing software instructions, but will conventionally be a microprocessor device. System memory 107 may include both a read-only memory (ROM) 109 and a random access memory (RAM) 111. As will be appreciated by those of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127.

Processing unit 105 and system memory 107 also may be directly or indirectly connected to one or more input devices 121 and one or more output devices 123. Input devices 121 may include, for example, a keyboard, a touch screen, a remote control pad, a pointing device (such as a mouse, touchpad, stylus, trackball, or joystick), a scanner, a camera or a microphone. Output devices 123 may include, for example, a monitor display, an integrated display, a television, a printer, a stereo, or speakers.

Still further, computing unit 103 may be directly or indirectly connected to one or more network interfaces 115 for communicating with a network. Network interface 115 is also sometimes referred to as a network adapter or network interface card (NIC). Network interface 115 translates data and control signals from computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. Network interface 115 may employ any suitable connection agent for connecting to a network, including, for example, a wireless transceiver, a power line adapter, a modem, or an Ethernet connection.

It should be appreciated that, in addition to the input, output, and storage peripheral devices specifically listed above, the computing device may be connected to a variety of other peripheral devices, including some that may perform input, output, and storage functions, or some combination thereof. For example, computer 101 may be connected to an iOS or Android based smartphone. As known in the art, smartphones can serve as both an output device for a computer (e.g., outputting sounds from a sound file or pictures from an image file) and a storage device.

Computer 101 may be connected to or otherwise include one or more other peripheral devices, such as a telephone. The telephone may be, for example, a wireless smart phone, such as those featuring the Android or iOS operating systems. As known in the art, this type of telephone communicates through a wireless network using radio frequency transmissions. In addition to simple communication functionality, a smart phone may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 101 so that data may be synchronized between the telephone and computer 101.

Of course, still other peripheral devices may be included with or otherwise connected to computer 101 illustrated in FIG. 1, as is well known in the art. In some cases, a peripheral device may be permanently or semi-permanently connected to computing unit 103. For example, with many computers, computing unit 103, hard disk drive 117, removable optical disk drive 119 and a display are semi-permanently encased in a single housing.

Still other peripheral devices may be removably connected to computer 101. Computer 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard, the IEEE 1394 High Speed Serial Bus standard (e.g., a Firewire port), or the ARINC 429 standard. Alternately or additionally, computer 101 may include a wireless data “port,” such as a Bluetooth® interface, a Wi-Fi interface, an infrared data port, or the like.

It should be appreciated that a computing device employed according to the various examples of the pilot assistance systems discussed herein may include more components than computer 101 illustrated in FIG. 1, fewer components than computer 101, or a different combination of components than computer 101. Some implementations of the invention, for example, may employ one or more computing devices that are configured for specific functions, such as a smart phone or server computer. These computing devices may thus omit unnecessary peripherals, such as network interface 115, removable optical disk drive 119, printers, scanners, external hard drives, etc. Some implementations of the invention may alternately or additionally employ computing devices that are configured for a wide variety of functions, such as a desktop or laptop personal computer. These computing devices may have any combination of peripheral devices or additional components as desired.

In many examples, computers may define mobile electronic devices, such as smartphones, tablet computers, or portable music players, often operating the iOS, Symbian, Windows-based (including Windows Mobile and Windows 8), Android operating systems, Linux variants, Real Time Operating Systems (RTOS), or possibly no operating system.

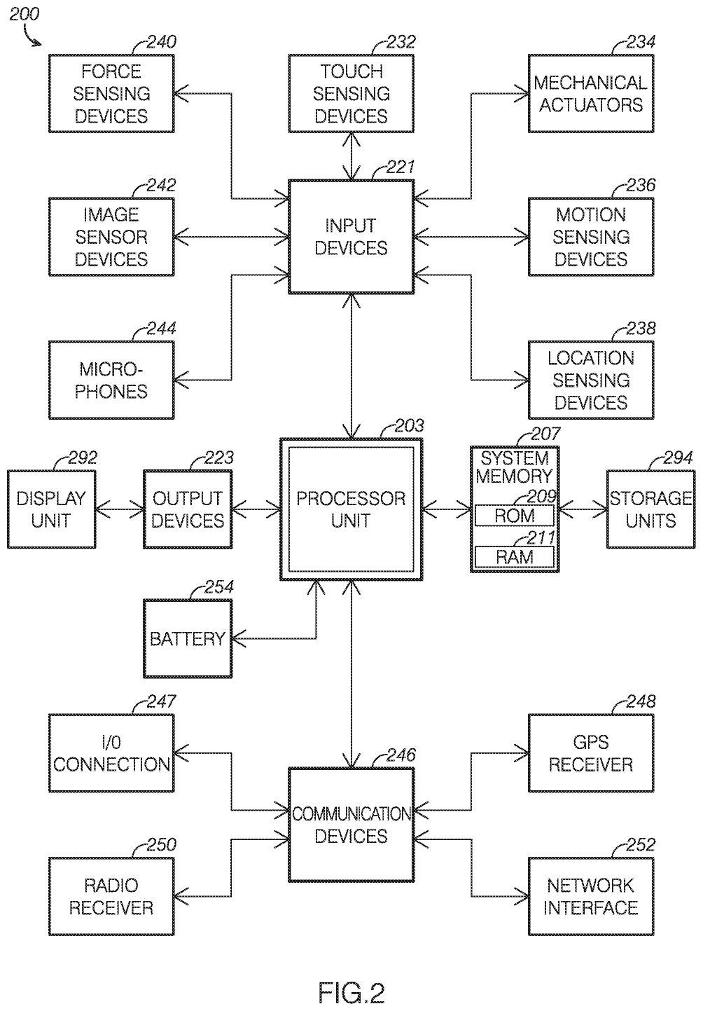

With reference to FIG. 2, an exemplary mobile device, mobile device 200, may include a processor unit 203 (e.g., CPU) configured to execute instructions and to carry out operations associated with the mobile device. For example, using instructions retrieved from memory, the controller may control receiving and manipulating input and output data between components of the mobile device. The controller can be implemented on a single chip, multiple chips or multiple electrical components. For example, various architectures can be used for the controller, including a dedicated or embedded processor, a single purpose processor, a controller, ASIC, etc. By way of example, the controller may include microprocessors, DSP, A/D converters, D/A converters, compression, decompression, etc.

In most cases, the controller together with an operating system operates to execute computer code and to produce and use data. The operating system may correspond to well-known operating systems, such as iOS, Symbian, Windows-based (including Windows Mobile and Windows 8), Android operating systems, Linux operating system variants, Real Time Operating Systems (RTOS). In some examples, no operating system is used. In certain examples, special purpose operating systems, such as those used for limited purpose appliance-type devices, are utilized. The operating system, other computer code, and data may reside within a system memory 207 that is operatively coupled to the controller. System memory 207 generally provides a place to store computer code and data that are used by the mobile device. By way of example, system memory 207 may include read-only memory (ROM) 209, random-access memory (RAM) 211, etc. Further, system memory 207 may retrieve data from storage units 294, which may include a hard disk drive, flash memory, etc. In conjunction with system memory 207, storage units 294 may include a removable storage device, such as an optical disc player that receives and plays DVDs, or card slots for receiving mediums, such as memory cards (or memory sticks).

Mobile device 200 also includes input devices 221 that are operatively coupled to processor unit 203. Input devices 221 are configured to transfer data from the outside world into mobile device 200. As shown in FIG. 2, input devices 221 may correspond to both data entry mechanisms and data capture mechanisms. In particular, input devices 221 may include touch sensing devices 232, such as touch screens, touch pads and touch sensing surfaces; mechanical actuators 234, such as button or wheels or hold switches; motion sensing devices 236, such as accelerometers; location detecting devices 238, such as global positioning satellite receivers, WiFi based location detection devices, or cellular radio based location detection devices; force sensing devices 240, such as force sensitive displays and housings; image sensors 242; and microphones 244. Input devices 221 may also include a clickable display actuator.

Mobile device 200 also includes various output devices 223 that are operatively coupled to processor unit 203. Output devices 223 are configured to transfer data from mobile device 200 to the outside world. Output devices 223 may include a display unit 292, such as an LCD, speakers or jacks, audio/tactile feedback devices, light indicators, and the like.

Mobile device 200 also includes various communication devices 246 that are operatively coupled to the controller. Communication devices 246 may, for example, include both an I/O connection 247 that may be wired or wirelessly connected to selected devices, such as through IR, USB, or Firewire protocols, a global positioning satellite receiver 248, and a radio receiver 250, which may be configured to communicate over wireless phone and data connections. Communication devices 246 may also include a network interface 252 configured to communicate with a computer network through various means, which may include wireless connectivity to a local wireless network, a wireless data connection to a cellular data network, a wired connection to a local or wide area computer network, or other suitable means for transmitting data over a computer network.

Mobile device 200 also includes a battery 254 and possibly a charging system. Battery 254 may be charged through a transformer and power cord or through a host device or through a docking station. In the cases of a docking station, charging may be transmitted through electrical ports or possibly through an inductance charging means that does not require a physical electrical connection to be made.

The various aspects, features, embodiments or implementations of computers embodying the pilot assistance systems described herein can be used alone or in various combinations. The pilot assistance systems' features can be implemented by software, hardware, or a combination of hardware and software. The pilot assistance systems can also be embodied as computer readable code on a computer readable medium. The computer readable medium may be any data storage device that can store data, which can thereafter be read by a computer system, including both transfer and non-transfer devices as defined above. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

Aircraft

The features of aircraft 302 will first be described to aid the discussion of the systems for assisting pilots disclosed herein. Aircraft 302 is an airplane, but may be any type of aircraft. Suitable aircraft types for utilizing the pilot assistance systems described herein include airplanes, rotorcrafts, powered lift vehicles, gliders, and airships.

Airports

The systems discussed below assist pilots to determine where best to attempt an emergency landing. The emergency landings may be attempted at airports, airstrips, fields, or other areas where a pilot may attempt to land an aircraft in an emergency.

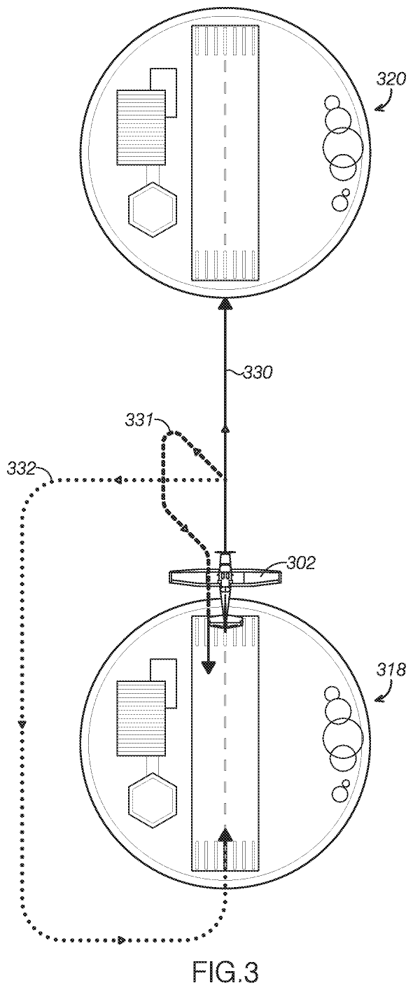

The airports depicted in FIG. 3 are a takeoff airport 318 and a second airport 320. The FIG. 3 airports are for schematic reference only and no particular airport features, structures, or characteristics are required for use with the systems discussed herein. The systems discussed herein may be programmed to identify, locate, and recommend any area, predetermined or determined in real-time, to be suitable for attempting a landing.

The reader should understand that the term airport is for convenience to describe a common and concrete example of where a pilot may land an aircraft. Beyond conventional airports with paved runways and aircraft infrastructure, the present disclosure's reference to airports contemplates less developed airstrips, infrastructure not intended for aircraft, such as roads, parking lots, and rooftops, or undeveloped areas of land where an aircraft could attempt an emergency landing.

In the example shown in FIG. 3, aircraft 302 is depicting departing or taking off from takeoff airport 318. Second airport 320 is schematically depicted in a different location than takeoff airport 320. The reader should understand that second airport may not be located directly ahead of aircraft 302 or takeoff airport 318, but instead could be located in any direction and could be any distance from aircraft 302 or takeoff airport 318. While two airports are depicted for conceptual simplicity, the systems described herein will typically consider multiple airports, such as all airports in a given region or reachable by a given airport. In some examples, the system limits consideration to a single airport, such as the takeoff airport.

Flight Paths

In FIG. 3, flight paths 330, 331, and 332, schematically depict simplified, potential flight paths aircraft 302 could take in an emergency. The reader should understand that flight paths 330-332 depicted in FIG. 3 are just three potential, representative flight paths and they are not intended to depict the actual flight path an aircraft may take to land at a given airport. The systems described herein are compatible with any particular flight path a pilot decides is best or necessary to reach a given airport or landing location.

Flight path 330 depicts aircraft 302 traveling to second airport 320 to attempt an emergency landing. Flight path 331 depicts aircraft 302 returning to takeoff airport 318 to attempt an emergency landing. Flight path 331 has aircraft 302 approaching takeoff airport 318 from a direction opposite that it departed from takeoff airport 318 to touch down proximate the same end of the runway where aircraft 302 took off.

Flight path 332 depicts aircraft 302 returning to takeoff airport 318 to attempt an emergency landing. Flight path 332 has aircraft 302 approaching takeoff airport 318 from a direction in line with the direction it was traveling when departing from takeoff airport 318 to touch down proximate the opposite end of the runway where aircraft 302 took off.

Systems for Assisting Pilots with Emergency Landings

With reference to the figures, systems for assisting pilots with emergency landings will now be described. The systems discussed herein function to assist pilots. More specifically, the present systems function to assist pilots in emergency scenarios. In particular, the presently disclosed systems assist pilots to determine where to land an aircraft in emergency scenarios. One specific emergency scenario where the systems assist pilots is when an aircraft is subject to an emergency during or shortly after takeoff.

In the event of an emergency, the currently disclosed systems evaluate where best to attempt an emergency landing and communicate instructions to the pilot. The system provides intentionally simple instructions to make the instructions easier to comprehend during the stress and confusion of an emergency flight scenario. The pilot maintains the ultimate decision whether to follow the instructions provided by the system, but the system provides objective, valuable information to assist the pilot with deciding how best to respond to the emergency circumstances.

The reader will appreciate from the figures and description below that the presently disclosed systems address many of the shortcomings of conventional avionics. For example, the present systems are designed to evaluate where best to attempt an emergency landing under emergency flight conditions unlike conventional systems that focus on guiding pilots with landing maneuvers to an airport selected by the pilot. The systems disclosed herein are superior to conventional avionics in their ability to provide clear, simple indications to the pilot rather than complex sets of information that are difficult to process in emergency flight scenarios. A further improvement over known avionics is the systems' ability to recognize an aircraft is in an emergency scenario and to quickly display information to assist with deciding where to attempt an emergency landing.

System Embodiment One

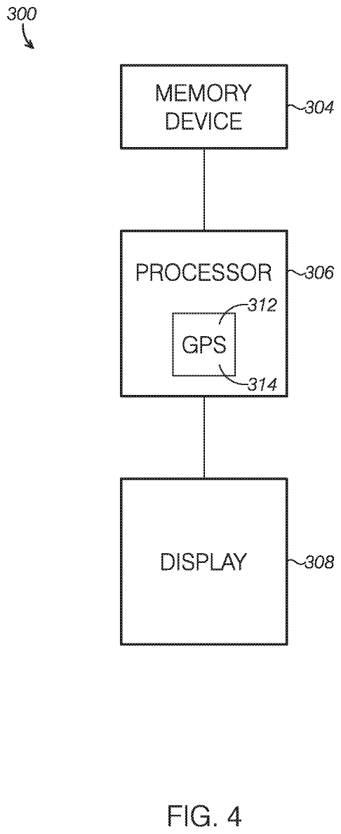

With reference to FIGS. 3-6, a first example of a system for assisting pilots with emergency landings, system 300, will now be described. As shown in FIG. 4, system 300 includes a memory device 304, a processor 306, a global positioning system 312, and a display 308. The reader will appreciate that the hardware components of system 300 may include the features described above in reference to FIGS. 1 and 2 for components with corresponding names in computer 100 and mobile device 200. Accordingly, for brevity, the discussion that follows will focus on additional noteworthy features of the components of system 100 and direct the reader to the discussion above with reference to FIGS. 1 and 2 for features of the components already discussed.

Memory Device

In the example shown in FIG. 4, memory device 304 functions to store computer executable instructions utilized by system 300. Memory device 304 is configured to store additional data beyond computer executable instructions as well, such as flight data, location data, airspeed data, engine performance data, altitude data, pitch data, and external condition data. The memory device may be any currently known or later developed type of memory device.

Processor

As shown in FIG. 4, processor 306 is in data communication with memory device 304. Processor 306 is configured to execute the computer executable instructions stored on memory device 304. Processor 306 is further configured to generate display instructions. In the present example, processor 306 is further configured to processes current location data corresponding to the current location of aircraft 302.

As can be seen in FIG. 4, processor 306 is in data communication with a global positioning system 312. In the particular example shown in FIG. 4, processor 306 includes a global positioning system processor 314. In other examples, the processor is in data communication with a global positioning system not in close physical proximity to the processor like global positioning system processor 314 is in close physical proximity to processor 306. Those skilled in the art will appreciate that global positioning system data may provide processor 316 with location information useful for processing computer executable instructions that utilize location data, such as the current position of aircraft 302. The global positioning system may be any currently known or later developed system for acquiring location data, whether integrated or discrete from the processor.

With further reference to the particular processor example shown in FIG. 4, processor 306 is configured to receive airspeed data from aircraft 302. Airspeed data includes the speed of aircraft 302 at a given time interval. Any currently known or later developed device or combination of devices for obtaining airspeed data may be used to supply airspeed data to the processor.

In the FIG. 4 example, processor 306 is configured to receive engine performance data from aircraft 302. The engine performance data may describe the operational characteristics of the aircraft's propulsion system at a given moment in time, including mechanical or electrical malfunctions. Any currently known or later developed device or combination of devices for obtaining engine performance data may be used to supply engine performance data to the processor.

With further reference to FIG. 4, processor 306 is configured to receive altitude data from aircraft 302. The altitude data may describe the altitude of aircraft 302 at a given moment in time. Any currently known or later developed device or combination of devices for obtaining altitude data may be used to supply engine performance data to the processor.

In the FIG. 4 example, processor 306 is configured to receive pitch data from aircraft 302. The pitch data may describe the pitch of aircraft 302 at a given moment in time. Any currently known or later developed device or combination of devices for obtaining pitch data may be used to supply pitch data to the processor.

With continued reference to FIG. 4, processor 306 is configured to receive external condition data from aircraft 302. The external condition data may describe conditions outside aircraft 302 at the given moment in time. In some examples, the external condition data includes wind speed near aircraft 302. Additionally or alternatively, the external condition data may include the direction of wind near aircraft 302. Any currently known or later developed device or combination of devices for obtaining external condition data may be used to supply external condition data to the processor.

Display

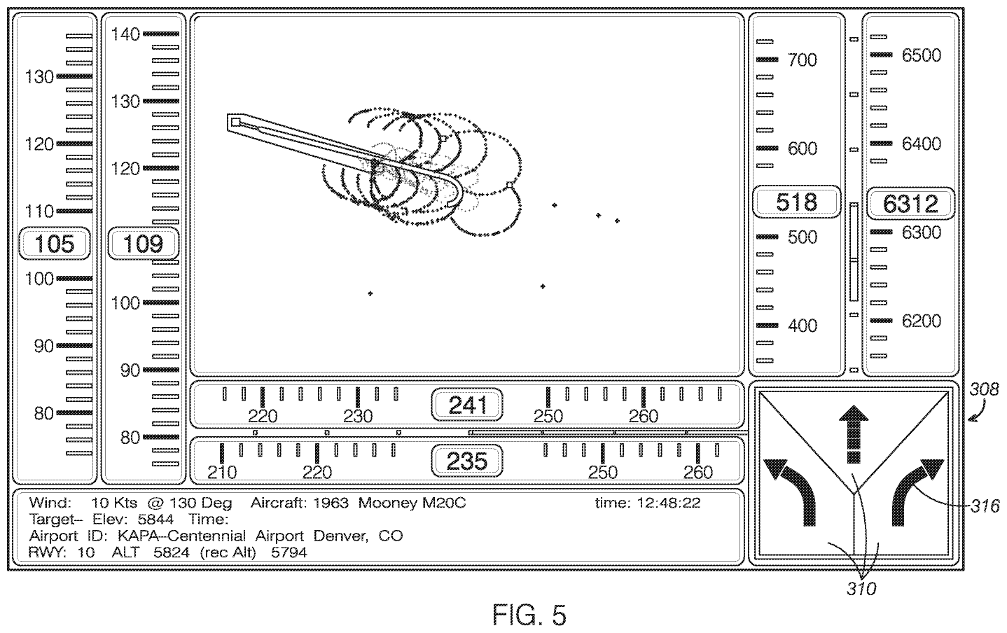

With reference to FIGS. 4 and 5, display 308 functions to display indicators 310 based on display instructions generated by processor 306. As shown in FIG. 4, display 308 is in data communication with processor 306. The device may be any currently known or later developed type of display device, including those described above with regard to FIGS. 1 and 2.

In the particular example shown in FIG. 5, display 308 is a liquid crystal display incorporated into a cockpit. The cockpit includes other displays beyond display 308. The other displays are displaying various flight related data, including aircraft speed, altitude, and direction information as well as wind information.

In the example shown in FIG. 5, display 308 is adjacent to alternative displays of data, including a graph of potential flight paths evaluated by system 300. In other examples, the display is separated to a larger degree and the amount of data related to the present system displayed on the display is minimized. For example, many examples of the present system exclude the graph of potential flight paths considered by the system to bring focus to the indicators displayed by the system. Separating the display from other displays of data serves to provide more clarity to the pilot assistance indicators and symbols displayed by the display of the present system. In some examples, the system displays only the indicators denoted as 310 in FIG. 5 and all the other data is not displayed.

In some examples, the display is configured to not display indicators or symbols unless the system detects an emergency or the pilot or other user manually prompts the system to display information. Expressed another way, in some examples the display is configured to activate only when needed, which helps make the system displaying information on the display more notable and attention grabbing.

Display 308 intentionally limits the information and indicators it displays to improve a pilot's ability to comprehend the information in an emergency scenario. Thus, display 308 displays just three indicators 310 corresponding to simple symbols 316 in the form of direction arrows. One arrow indicates a turn to the left, the second arrow indicates forward travel, and the third arrow indicates a turn to the right. In an emergency scenario where system 300 functions to assist pilots, display 308 will highlight one of the three symbols corresponding to the direction of the airport determined to be most suitable for attempting the emergency landing.

In the present example, system 300 instructs display 308 to display three indicators 310 and three symbols 316. In other examples, the system instructs the display to display different numbers of indicators and symbols, such as one, two, or three or more indicators and a corresponding or independent number of symbols. While symbols 316 are arrows, any form of symbol may be displayed, such as circles or other simple shapes, flight related icons, animations, text, or numbers.

Computer Executable Instructions

System 300 utilizes computer executable instructions in conjunction with the hardware components discussed above to assist pilots. The computer executable instructions instruct the system in various ways, including instructions to detect emergencies, to evaluate suitable airports or other areas suitable for attempting an emergency landing, and to communicate a recommended airport or landing area to a pilot. The computer executable instructions described herein are not intended to be exhaustive or inclusive of all instructions contemplated or utilized by system 300. Instead, the computer executable instructions discussed here serve to highlight the novel pilot assistance methods and capabilities of the pilot assistance systems disclosed herein.

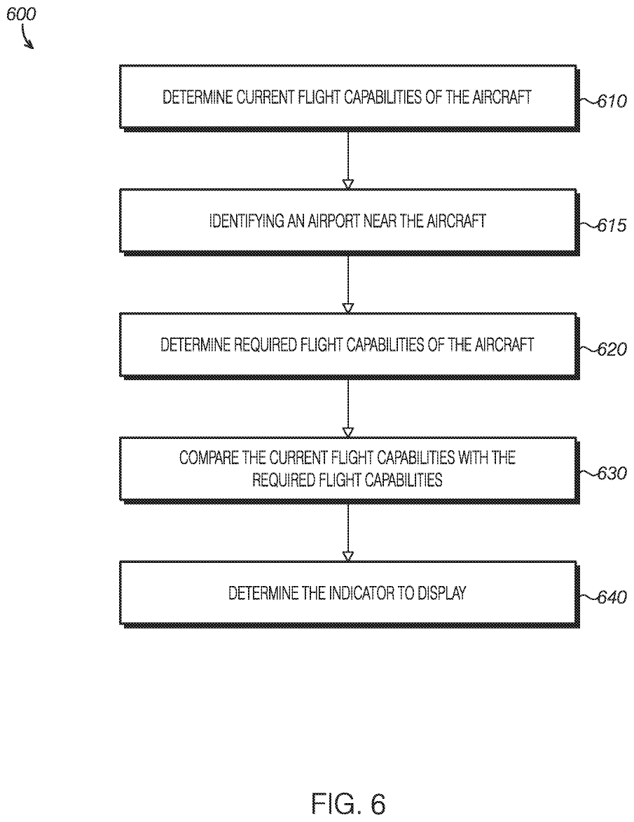

As shown in FIG. 6, the computer executable instructions include instructions for determining current flight capabilities of aircraft 302 at a given moment at step 610. In the current example, determining current flight capabilities of aircraft 302 at step 610 includes evaluating airspeed data received by processor 306. In system 300, determining current flight capabilities of aircraft 302 at step 610 further includes evaluating engine performance data received by processor 306. The computer executable instructions of system 300 also include evaluating altitude data and pitch data received by processor 306 as part of determining current flight capabilities of aircraft 302 at step 610.

At step 615, the computer executable instructions provide for identifying an airport near aircraft 302 at the given moment. In the present example, identifying an airport near aircraft 302 at the given moment at step 615 includes identifying airport location data corresponding to the location of the airport. In system 300, identifying an airport near aircraft 302 at the given moment at step 615 includes identifying a takeoff airport 318 from which aircraft 302 took off and a second airport 320 in another location than takeoff airport 318.

In some examples, identifying an airport near the aircraft at the given moment is limited to identifying a takeoff airport from which the aircraft most recently departed, such as takeoff airport 318 depicted in FIG. 3. Limiting the airport identification focus to the airport in which the aircraft most recently departed is a design choice that may be employed to optimize performance for scenarios where an aircraft experiences an emergency during or shortly after takeoff. By focusing the analysis to whether a pilot should attempt an emergency landing at a takeoff airport from which he or she just departed, the system may respond more quickly, more reliably, or more in keeping with aviation guidelines or expectations than might occur if other airport options were concurrently considered. Of course, tracking additional airport locations is contemplated and useful for emergency scenarios that arise when the aircraft is no longer near its takeoff airport.

As shown in FIG. 6, the computer executable instructions include determining required flight capabilities of aircraft 302 necessary for aircraft 302 to land safely at the airport at the given moment at step 620. In the present example, determining required flight capabilities of aircraft 302 at step 620 includes comparing the current location data with the airport location data. In system 300, determining required flight capabilities of aircraft 302 at step 620 includes evaluating the external condition data.

At step 630, the instructions provide for processor 306 to compare the current flight capabilities of aircraft 302 with the required flight capabilities of aircraft 302 necessary for aircraft 302 to land safely at the airport. A wide variety of methods and criteria known by those skilled in the aviation may be used to compare the current flight capabilities with the required flight capabilities.

The comparison may indicate that aircraft 302 could not safely land at a given airport or could land safely at a given airport with a high degree of confidence. In between comparisons that yield strong indications of either an ability or inability to land safely at a given airport may be comparisons less certain indications. The less certain indications may indicate that aircraft 302 could possibly land safely at a given airport, but possibly may not be able to land safely there.

In the present example, the instructions for comparing the current flight capabilities with the required flight capabilities at step 630 include determining a confidence factor for the comparison. System 300 includes a predetermined confidence threshold stored in memory 304 above which the confidence factor must be for system 300 to unequivocally indicate that aircraft 302 could safely land at a given airport. Thus, system 300 includes instructions for comparing the confidence factor to the confidence threshold when evaluating where to recommend attempting an emergency landing.

In the present example, the computer executable instructions include determining an indicator to display on display 308 based on the comparison of the current flight capabilities of aircraft 302 with the required flight capabilities of aircraft 302 necessary for aircraft 302 to land safely at the airport at step 640. In the present example, determining the indicator to display at step 640 includes selecting a symbol 316 to display. In system 300, determining the indicator to display at step 640 further includes selecting a color of indicator 310.

Various schemes may be employed when selecting colors to display. In the present example, selecting a color at step 640 is designed to display colors commonly associated with danger or stop actions, with caution or proceed slowly actions, and with safe and proceed normally actions. The FAA or other administrative agency may mandate particular colors be used, and the colors discussed herein may be modified accordingly to comply with such mandates.

In particular, selecting a color of indicator 310 at step 640 includes selecting a red color if the comparison of the current flight capabilities of aircraft 302 with the required flight capabilities of aircraft 302 necessary for aircraft 302 to land safely at the airport indicates that aircraft 302 could not safely land at the airport. System 300 is configured to select a yellow color if the comparison of the current flight capabilities of aircraft 302 with the required flight capabilities of aircraft 302 necessary for aircraft 302 to land safely at the airport indicates that aircraft 302 could safely land at the airport and a confidence assessment falls below a predetermined confidence threshold. At step 640, a green color is selected if the comparison of the current flight capabilities of aircraft 302 with the required flight capabilities of aircraft 302 necessary for aircraft 302 to land safely at the airport indicates that aircraft 302 could safely land at the airport. In other examples, other colors and other color selection criteria are used.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A system for assisting pilots with an emergency landing of an aircraft, comprising:
a memory device storing computer executable instructions;
a processor in data communication with the memory device, the processor configured to:
execute the computer executable instructions; and
generate display instructions; and
a display in data communication with the processor and configured to display an indicator based on the display instructions generated by the processor;
wherein the computer executable instructions include instructions for:
determining current flight capabilities of the aircraft at a given moment;
identifying an airport near the aircraft at the given moment;
determining required flight capabilities of the aircraft necessary for the aircraft to land safely at the airport at the given moment;
comparing the current flight capabilities of the aircraft with the required flight capabilities of the aircraft necessary for the aircraft to land safely at the airport; and
determining the indicator to display on the display based on the comparison of the current flight capabilities of the aircraft with the required flight capabilities of the aircraft necessary for the aircraft to land safely at the airport.

2. The system of claim 1, wherein:
the processor is further configured to processes current location data corresponding to the current location of the aircraft;
identifying an airport near the aircraft at the given moment includes identifying airport location data corresponding to the location of the airport; and
determining required flight capabilities of the aircraft necessary for the aircraft to land safely at the airport at the given moment includes comparing the current location data with the airport location data.

3. The system of claim 2, wherein the processor is in data communication with a global positioning system.

4. The system of claim 2, wherein the processor includes a global positioning system processor.

5. The system of claim 1, wherein:
the processor is configured to receive airspeed data from the aircraft; and
determining current flight capabilities of the aircraft includes evaluating the airspeed data.

6. The system of claim 1, wherein:
the processor is configured to receive engine performance data from the aircraft; and
determining current flight capabilities of the aircraft includes evaluating the engine performance data.

7. The system of claim 1, wherein:
the processor is configured to receive altitude data from the aircraft; and
determining current flight capabilities of the aircraft includes evaluating the altitude data.

8. The system of claim 1, wherein:
the processor is configured to receive pitch data from the aircraft; and
determining current flight capabilities of the aircraft includes evaluating the pitch data.

9. The system of claim 1, wherein:
the processor is configured to receive external condition data corresponding to conditions outside the aircraft at the given moment;
determining required flight capabilities of the aircraft includes evaluating the external condition data.

10. The system of claim 9, wherein the external condition data includes wind speed.

11. The system of claim 10 wherein the external condition data includes wind direction.

12. The system of claim 1, wherein determining the indicator to display includes selecting a symbol to display.

13. The system of claim 1, wherein determining the indicator to display includes selecting a color of the indicator.

14. The system of claim 13, wherein selecting a color of the indicator includes selecting:
a red color if the comparison of the current flight capabilities of the aircraft with the required flight capabilities of the aircraft necessary for the aircraft to land safely at the airport indicates that the aircraft could not safely land at the airport; and
a green color if the comparison of the current flight capabilities of the aircraft with the required flight capabilities of the aircraft necessary for the aircraft to land safely at the airport indicates that the aircraft could safely land at the airport.

15. The system of claim 14, wherein selecting a color of the indicator includes selecting a yellow color if the comparison of the current flight capabilities of the aircraft with the required flight capabilities of the aircraft necessary for the aircraft to land safely at the airport indicates that the aircraft could safely land at the airport and a confidence assessment falls below a predetermined confidence threshold.

16. The system of claim 1, wherein identifying an airport near the aircraft at the given moment consists of identifying a takeoff airport from which the aircraft took off.

17. The system of claim 1, wherein identifying an airport near the aircraft at the given moment includes identifying a takeoff airport from which the aircraft took off and a second airport in another location than the takeoff airport.

18. A system for assisting pilots with an emergency landing of an aircraft near a takeoff airport from which the aircraft takes off, comprising:
a memory device storing computer executable instructions;
a processor in data communication with the memory device, the processor configured to:
execute the computer executable instructions; and
generate display instructions; and
a display in data communication with the processor and configured to display an indicator based on the display instructions generated by the processor;
wherein the computer executable instructions include instructions for:
determining current flight capabilities of the aircraft at a given moment;
determining required flight capabilities of the aircraft necessary for the aircraft to land safely at the takeoff airport;
comparing the current flight capabilities of the aircraft with the required flight capabilities of the aircraft necessary for the aircraft to land safely at the takeoff airport; and
determining the indicator to display on the display based on the comparison of the current flight capabilities of the aircraft with the required flight capabilities of the aircraft necessary for the aircraft to land safely at the takeoff airport.

19. The system of claim 18, wherein:
the processor is further configured to processes current location data from a global positioning system corresponding to the current location of the aircraft;
identifying an airport near the aircraft at the given moment includes identifying airport location data corresponding to the location of the airport; and
determining required flight capabilities of the aircraft necessary for the aircraft to land safely at the airport at the given moment includes comparing the current location data with the airport location data.

20. The system of claim 19, wherein:
the processor is configured to receive:
airspeed data from the aircraft;
engine performance data from the aircraft;
altitude data from the aircraft;
pitch data from the aircraft; and
external condition data corresponding to conditions outside the aircraft at the given moment; and
determining current flight capabilities of the aircraft includes:
evaluating the airspeed data;
evaluating the engine performance data;
evaluating the altitude data;
evaluating the pitch data; and
evaluating the external condition data.
